(19) United States
(12) Patent Application Publication
(10) Pub. No.: US 2005/0089732 A1
(43) Pub. Date: Apr. 28, 2005

(54) Fuel reforming system and fuel cell system having same

(76) Inventors: Takashi Aoyama, Kanagawa (JP); Keiji Okada, Kanagawa (JP); Yasukazu Iwasaki, Kanagawa (JP); Fumihiro Haga, Kanagawa (JP)

Correspondence Address: MCDermott Will & Emery, 600 13th Street NW, Washington, DC, 20005-3096, US

(21) Appl. No.: 10/503,443

(22) PCT Filed: Jan. 24, 2003
(86) PCT No.: PCT/JP03/00630

(30) Foreign Application Priority Data
Feb. 8, 2002 (JP) 200232386
Nov. 19, 2002 (JP) 2002335036

(51) Int. Cl. H01M 8/04; H01M 8/06; B01J 8/00

(52) U.S. Cl. 429/20; 429/23; 429/13; 422/105; 422/198

(57) ABSTRACT

A fuel reforming system, comprising a reformer (2, 3, 4) which produces reformate gas from rich raw fuel gas, and supplies the reformate gas to the fuel cell (28) during a reforming operation, a burner (1) which produces lean combustion gas, and supplies the lean combustion gas to the reformer (2, 3, 4) during a warmup operation of the reformer (2, 3, 4), and a nonflammable fluid supply apparatus which supplies a nonflammable fluid other than fuel and air to the reformer (2, 3, 4). During the warmup operation of the reformer (2, 3, 4), the lean combustion gas is supplied from the burner (1) to the reformer (2, 3, 4), and when warmup of the reformer (2, 3, 4) is complete, the nonflammable fluid is supplied from the nonflammable fluid supply apparatus to the reformer (2, 3, 4), and the reforming operation of the reformer (2, 3, 4) then starts.

### FIELD OF THE INVENTION

The present invention relates to a fuel reforming system and a fuel cell system provided with that, and in particular, to a shift from warm-up operation to reforming operation of the reformer.

### BACKGROUND OF THE INVENTION

A fuel reforming system disclosed in JP2000-63104A published by the Japanese Patent Office in 2000, comprises a burner upstream of the reforming system. When the reforming system is warmed up, a reforming catalyst is raised to a predetermined temperature by supplying fuel and air to the burner and supplying the generated combustion gas to the reforming system. The temperature of the combustion gas is determined taking account of the warm-up performance and heat-resisting property of each part. Moreover, combustion near the stoichiometric air-fuel ratio where the combustion temperature is high, is avoided, and combustion is performed at a rich or lean air-fuel ratio. When the reforming catalyst reaches a predetermined temperature, raw fuel gas and air for reforming is supplied to the reforming system, and the reforming operation starts.

Reforming reactions of hydrocarbon fuel may be broadly divided into steam reforming reactions and partial oxidation reactions. The steam reforming reaction is expressed by the following equation:
CₘHₙ+mH₂O→(m+n/2)H₂+mCO (1)

The reactions expressed by the following equations also occur.
3H₂+CO→CH4+H₂O (2)
2H₂+2CO→CH₄+CO₂ (3)

When the reforming condition is maintained at high temperature, the reaction of equation (1) mainly takes place, and the hydrogen and CO in the reformate gas increase. The reaction rate of equations (2) and (3) increases at low temperature, the concentrations of hydrogen and CO in the reformate gas decrease, and the concentration of methane, water, etc. increases. The reaction of equation (1) is an endothermic reaction, and in order to maintain the reaction, heat must be supplied.

On the other hand, the partial oxidation reaction is expressed by the following equation:
CₘHₙ+(m/2)O₂→(n/2)H₂+mCO (4)

This reaction is an exothermic reaction, so the reaction is maintained by adjusting the fuel gas supply amount for reforming and the oxygen (air) supply amount.

Also, by performing steam reforming and the partial oxidation reaction at the same place, autothermal reforming can be performed which maintains the reforming reactions by maintaining an endothermic and exothermic balance. In any case, the reforming reaction is carried out in a rich condition rather than at the stoichiometric air-fuel ratio.

### SUMMARY OF THE INVENTION

In a conventional fuel cell system, warm-up of the reforming system is performed using the combustion gas generated by combustion at a lean air-fuel ratio (λ=2-5) in a startup burner. Therefore, when warm-up is complete and there is a shift to reforming operation (i.e., when shifting to the rich running state (λ=0.2-0.5)), there is a region in the reforming system which is near the stoichiometric air-fuel ratio (λ=1).

When this region reaches the catalyst of the reactor in the reforming system and causes a reaction to occur on the catalyst, a high temperature of 2000° C. or more may be reached, and the catalyst performance may be largely degraded, or the carrier supporting the catalyst, or the reactor itself, may be damaged.

It is therefore an object of this invention to prevent air-fuel mixture of stoichiometric air-fuel ratio from being within each reactor of a fuel cell system when there is a change-over of the reforming system from warm-up to reforming.

In order to achieve above object, the present invention provides a fuel reforming system including a reformer which produces the reformate gas from the rich raw fuel gas during a reforming operation, a burner which produces lean combustion gas, and supplies the lean combustion gas to the reformer during a warmup operation thereof, a nonflammable fluid supply apparatus which supplies a nonflammable fluid other than fuel and air to the reformer, and a controller. The controller functions to supply the lean combustion gas from the burner to the reformer during the warmup operation and when the warmup operation is complete, supply the nonflammable fluid from the nonflammable fluid supply apparatus to the reformer, and then supply the rich raw fuel gas to the reformer to start fuel reforming.

According to an aspect of the invention, this invention provides a control method of a fuel reforming system having a reformer which produces the reformate gas from the rich raw fuel gas during a reforming operation and a burner which produces lean combustion gas and supplies the lean combustion gas to the reformer during a warmup operation thereof, the method comprising supplying the lean combustion gas from the burner to the reformer during the warmup operation and when the warmup operation is complete, supplying the nonflammable fluid to the reformer, and then supplying the rich raw fuel gas to the reformer to start fuel reforming.

The details as well as other features and advantages of this invention are set forth in the remainder of the specification and are shown in the accompanying drawings.

### BRIEF DESCRIPTION OF THE DRAWINGS

FIG. 1 is a block diagram of a fuel cell system according to a first embodiment.

FIG. 2 is a flowchart of a control performed during startup in the first embodiment.

FIG. 3 is a flowchart of a control of a change-over from warmup operation to reforming operation in the first embodiment.

FIGS. 4A-4E are timing charts when operation is changed over in the first embodiment.

FIG. 5 is a flowchart of an operation change-over control according to a second embodiment.

FIGS. 6A-6E are timing charts when an operation is changed over in the second embodiment.

FIG. 7 is a block diagram of the fuel cell system according to a third embodiment.

FIG. 8 is a flowchart of an operation change-over control in the third embodiment.

FIG. 9 is a comparison of adiabatic flame temperature in this invention and a comparative example.

FIG. 10 is a figure showing the state of the gas in the reformer when there is an operation change-over in the comparative example.

FIG. 11 is a figure showing the state of the gas in the reformer when there is an operation change-over in this invention.

FIG. 12 is a block diagram of a fuel cell system according to a fourth embodiment.

FIG. 13 is a flowchart of an operation change-over control in the fourth embodiment.

FIGS. 14A-14E are timing charts when there is an operation change-over in the fourth embodiment.

FIG. 15 is a block diagram of the fuel cell system according to a fifth embodiment.

FIG. 16 is a flowchart of an operation change control in the fifth embodiment.

FIG. 17 is a subroutine of the operation change control shown in FIG. 16.

FIGS. 18A-18E are timing charts when there is an operation change-over in the fifth embodiment.

FIG. 19 is a block diagram of a fuel cell system according to a sixth embodiment.

FIGS. 20A-20E are timing charts when there is an operation change-over in the sixth embodiment.

FIG. 21 is a block diagram of a fuel cell system according to a seventh embodiment.

FIG. 22 is a flowchart of an operation change control in the seventh embodiment.

FIGS. 23A-23B are figures showing the change of catalyst temperature when there is an operation change-over in the seventh embodiment.

FIGS. 24A-24B are figures showing the change of catalyst temperature when there is an operation shift in the comparative example.

### DETAILED DESCRIPTION OF THE INVENTION

Embodiment 1

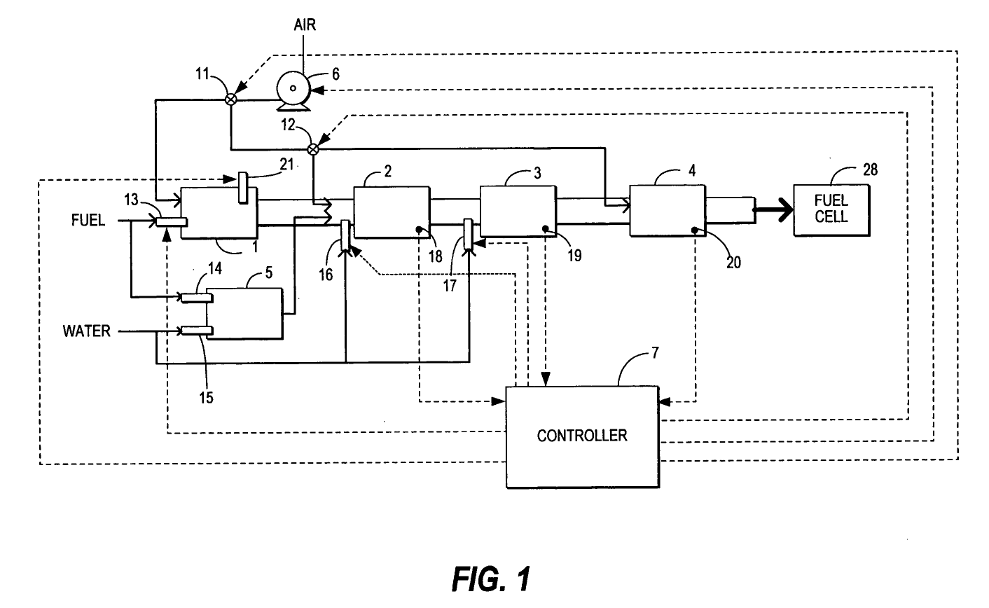

FIG. 1 of the drawings shows the construction of the fuel cell system of a first embodiment. The fuel cell system includes a fuel cell 28 and a fuel reforming system (i.e. other components in FIG. 1). A startup burner 1 generates combustion gas for warming up a reformer (reforming reactor 2, shift reactor 3, CO removal reactor 4) of the fuel reforming system when the fuel cell system starts. When fuel is supplied from a fuel injection valve 13 and air is supplied through an air feeder 6 (e.g. blower, compressor, etc.) to the startup burner 1, fuel is ignited by an ignition source 21 such as a spark plug or a glow plug. A combustion air-fuel ratio is set to be leaner than the stoichiometric air-fuel ratio. Taking account of the heat-resisting properties and exhaust performance of the fuel reforming system, the air-excess ratio λ is set in the region of 2-5. The air-excess ratio λ is the ratio of the supply air amount to the air amount theoretically required to burn the fuel completely.

The hot combustion gas generated by the startup burner 1 is supplied to the reformer, and the warmup of the reformer is performed.

In the warmup operation, air from the air feeder 6 is supplied only to the startup burner 1 via a flowpath change-over valve 11. The flowpath change-over valve 11 is a change-over valve which changes over the supply of air from the air feeder 6, to the startup burner 1, or to the reforming reactor 2 and the CO removal reactor 4 of the reformer, or a regulating valve which adjusts the supply rate to these destinations, respectively. When the reformer warms up, the flowpath change-over valve 11 is controlled to supply air to the startup burner 1, and during the reforming operation, to supply air to the reforming reactor 2 and CO removal reactor 4.

The reformer comprises the reforming reactor 2, shift reactor 3 and CO removal reactor 4, and during the reforming operation, reforms hydrocarbon fuel to generate hydrogen-rich gas.

During the reforming operation, hydrocarbon fuel whereof the flowrate is adjusted by a fuel feeder 14, and water whereof the flowrate is adjusted by a water feeder 15, are supplied to a vaporizer 5, and the hydrocarbon fuel mixes with the water and vaporizes so that raw fuel gas used for the reforming reaction is generated. The heat required for vaporization is supplied by heat exchange with an electric heater or another burners. The vaporizer 5 may be a type which vaporizes fuel and water separately, or an integrated type which vaporizes them together. Examples of hydrocarbon fuels are gasoline, natural gas and alcohols such as methanol (similar for the other embodiments).

The raw fuel gas (mixture of fuel gas and water vapor) generated by the vaporizer 5 is supplied to the reforming reactor 2. The reforming reactor 2 is for example an autothermal type reforming reactor. In the reforming reactor 2, hydrogen-rich reformate gas is generated by the reforming reaction using the raw fuel gas and the oxygen in the air supplied via the flowpath change-over valves 11, 12. The flowrate change-over valve 12 is disposed downstream of the flowpath change-over valve 11, and distributes air whereof the flowrate was adjusted by the flow rate change-over valve 11 to the reforming device 2 and CO removal reactor 4. During the reforming operation, the reforming reactor 2 uses a gas proportion richer than gas having the stoichiometric air-fuel ratio, for example gas having an air-excess ratio λ of 0.2 to 0.5, and herein, rich gas having an air-fuel excess λ of 0.35 is used.

In order to remove the carbon monoxide in the reformate gas generated in the reforming reaction, water is mixed with the reformate gas generated in the reforming reactor 2 from the water feeder 17, and supplied to the shift reactor 3.

In the shift reactor 3, carbon monoxide which causes deterioration of the Pt catalyst filled in the fuel cell stack 28 is removed by the shift reaction (CO+H₂O→H₂+CO₂). The reformate gas of which the carbon monoxide concentration was reduced in the shift reactor 3, is supplied to the CO removal reactor 4.

In the CO removal reactor 4, carbon monoxide is further removed by a preferential oxidation reaction (CO+1/2O₂→CO₂), which is an exothermic reaction. The reformate gas which now has a low carbon monoxide concentration is supplied to the fuel cell stack 28, and the fuel cell stack 28 generates power according to the electrochemical reaction of the hydrogen in the reformate gas, and the oxygen in air.

The reactors 2-4 are filled with the catalyst, respectively, and respectively have their optimal operation temperatures. Therefore, when the fuel reforming system starts up, temperature sensors 18, 19, 20 fitted to the reactors 2-4 detect the catalyst temperature of each of the reactors 2, 3, 4, and it is determined whether or not the warmup of the reformer is complete by determining whether the catalyst temperature of the reactors 2-4 has risen to a target warmup temperature.

When it is determined that each of the reactors 2-4 has reached the target temperature, warmup operation of the fuel reforming system is terminated and the reforming operation is started. Until the time when the reforming operation starts, the aforesaid vaporizer 5 is warmed up by an electric heater or another burner, and when the reforming reaction starts, a predetermined amount of fuel gas is supplied to the reforming reactor 2.

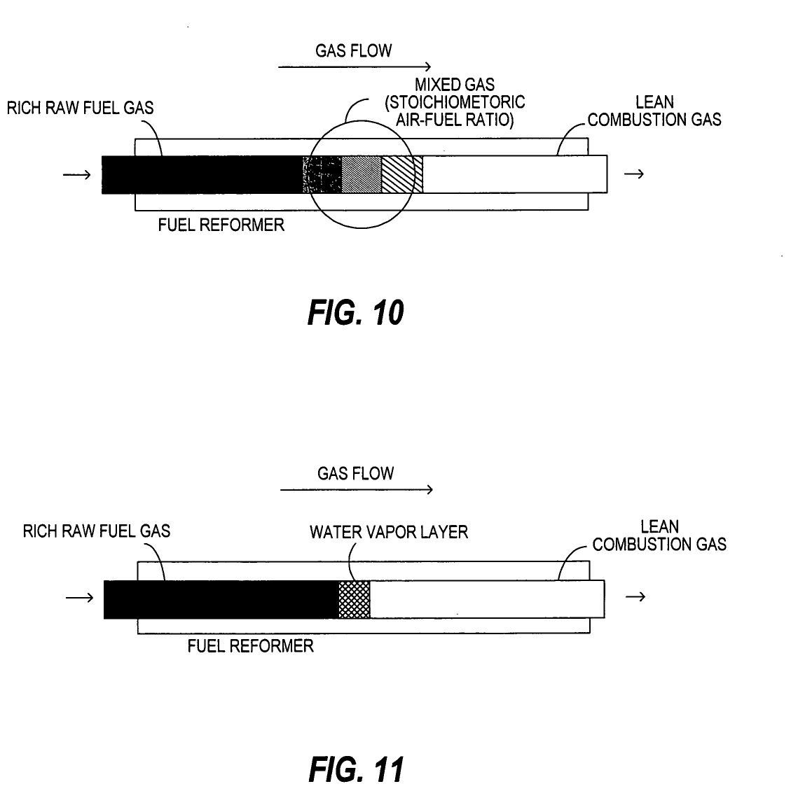

When the reforming system shifts from the warmup operation to the reforming operation, if the operation state is merely changed over, lean combustion gas for warmup and rich raw fuel gas for reforming, will be mixed in the boundary region, and a mixed gas having an air-fuel ratio near the stoichiometric air-fuel ratio will be produced, as shown in FIG. 10. If the mixed gas near the stoichiometric air-fuel ratio reacts on the catalysts of the reactors 2-4, the temperature in the reformer will rise excessively.

Therefore, a water feeder 16 which supplies water to the upstream of the reforming reactor 2 is installed as shown in FIG. 1. Water is supplied between the lean combustion gas supplied during the warmup operation and the rich raw fuel gas supplied during the reforming operation from the water feeder 16 and vaporized, so as to form a layer of water vapor. The water vapor layer prevents the lean combustion gas and the rich raw fuel gas from mixing to give the stoichiometric air-fuel ratio.

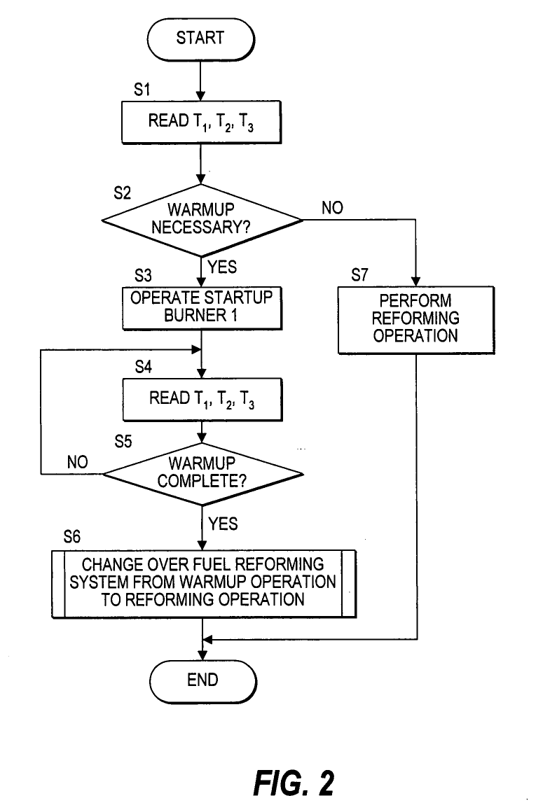

The control performed when the fuel reforming system shifts from the warmup operation to the reforming operation, is shown in the flowchart of FIG. 2. This flowchart is performed by the controller 7. The controller 7 comprises one, two or more microprocessors, a memory, and an input/output interface, etc.

In a step S1, catalyst temperatures T₁, T₂, T₃ of each of the reactors 2-4 detected by the temperature sensors 18-20 are read. In a step S2, it is determined whether or not the catalyst temperature T₁, T₂, T₃ of each of the reactors 2-4 has reached the target warmup temperature. If all the reactors 2, 3, 4 have reached the target warmup temperatures, it is determined that there is no need for the warmup operation, and the routine proceeds to a step S7.

In the step S7, the fuel feeder 14 and water feeder 15 are controlled to supply fuel and water to the vaporizer 5. Simultaneously, by controlling the flowpath change-over valve 11, air is supplied to the reforming reactor 2 and CO removal reactor 4, and the reforming operation is performed.

If some of the reactors 2-4 have not reached the target warmup temperatures in the step S2, the routine proceeds to a step S3 and the warmup operation of the fuel reforming system is started. Specifically, the flowpath change-over valve 11 is changed over to the startup burner 1 to supply air to the startup burner 1, fuel is supplied from the fuel injection valve 13, and combustion is started. The generated lean combustion gas is supplied to the reformer.

In a step S4, the catalyst temperatures T₁, T₂, T₃ of each of the reactors 2-4 detected by the temperature sensors 18-20 are read. In a step S5, the completion of warmup is determined by determining whether the catalyst temperature T₁, T₂, T₃ of each of the reactors 2-4 has reached the target warmup temperature. If the target warmup temperature has not been reached, the routine returns to the step S4, and the catalyst temperatures T₁, T₂, T₃ of the reactors 2-4 are read again. The warmup operation is continued until the catalyst temperatures T₁, T₂, T₃ of the reactors 2-4 reach the target warmup temperatures, and when the target warmup temperatures are reached, it is determined that warmup is complete and the routine proceeds to a step S6.

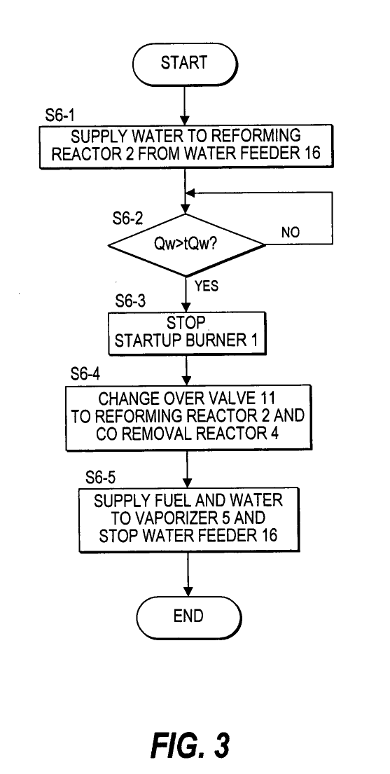

In the step S6, the fuel reforming system is changed over from the warmup operation to the reforming operation. This will now be described referring to the flowchart in FIG. 3 showing the change-over control from the warmup operation to the reforming operation.

In a step S6-1, the water feeder 16 is operated and supply of water to the reforming reactor 2 is started. The supplied water is vaporized, and a layer of water vapor is formed between the lean combustion gas and rich raw fuel gas. In a step S6-2, it is determined whether or not the water supply amount Qw from the water feeder 16 has exceeded a predetermined amount tQw. This determination is repeated until it exceeds the predetermined amount tQw, and when it exceeds the predetermined amount tQw, the routine proceeds to a step S6-3.

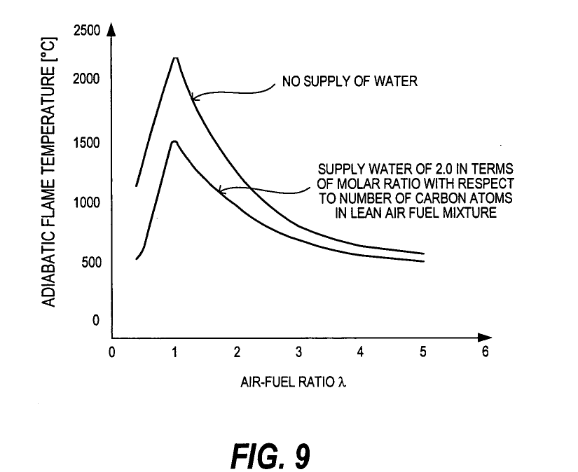

The predetermined amount tQw is set to 2.0 or more in terms of molar ratio relative to the number of carbon atoms in the hydrocarbon fuel of the lean air-fuel mixture supplied to the fuel reforming system. Thereby, as shown in FIG. 9, the reaction temperature of the hot combustion gas in the catalyst layer after completion of warmup can be controlled to 1000° C. or less, and the catalysts of the reactors 2-4 can be protected.

In a step S6-3, the fuel injection valve 13 is closed, the fuel supply to the startup burner 1 is stopped, and production of combustion gas is stopped. In a step S6-4, the flowpath change-over valve 11 is changed over to supply air to the reforming reactor 2 and CO removal reactor 4. In a step S6-5, the fuel feeder 14 and water feeder 15 are controlled to supply fuel and water to the vaporizer 5. Simultaneously, the water feeder 16 is stopped, and the change-over control from the warmup operation to the reforming operation is terminated.

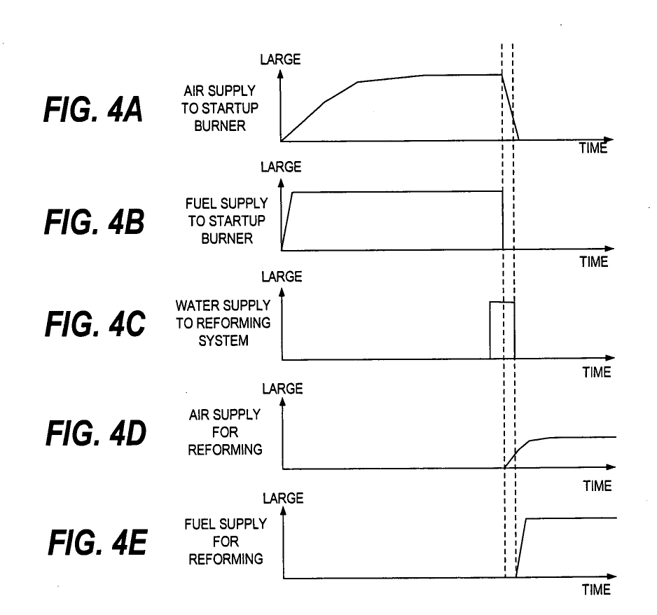

FIGS. 4A-4E are timing charts at the time when the reforming system shifts from the warmup operation to the reforming operation. In the first embodiment, after a water vapor layer is formed by the water supplied by the water feeder 16, the fuel supply to the startup burner 1 is stopped, and subsequently, supply of air for reforming is started, and then supply of fuel for reforming is started.

According to the first embodiment, the fuel cell system is provided with the fuel reforming system comprising the reformer having the reforming reactor 2 which generates reformate gas from hydrocarbon fuel, and the CO reduction system (the shift reactor 3, CO removal reactor 4) which reduces CO in the reformate gas generated by the reforming reactor 2. The fuel reforming system also comprises the startup burner 1 which generates combustion gas for warming up the reformer when the fuel cell system starts.

When the fuel cell system starts, combustion gas having an air-fuel ratio leaner than the stoichiometric air-fuel ratio produced by the startup burner 1 is supplied to the reformer, and the reformer is warmed up. After the warmup of the reformer is complete, the reforming operation is performed in the reforming reactor 2 using raw fuel gas having an air-fuel ratio richer than the stoichiometric air-fuel ratio. The system further comprises the feeder (water feeder 16) which, when the fuel reforming system shifts from the warmup operation to the reforming operation, supplies a nonflammable fluid other than fuel and air between the lean combustion gas and rich raw fuel gas supplied to the reformer. The nonflammable fluid supplied prevents lean combustion gas and rich raw fuel gas from mixing, and the stoichiometric air-fuel ratio state is thereby prevented from occurring within the reformer.

For example, the nonflammable fluid is a gas which is at least inert to fuel. By supplying an inert gas, reactions in the reformer can be suppressed. Thus, the temperature of the reformer is prevented from rising excessively. Moreover, even if a gas reaction near the stoichiometric air-fuel ratio takes place in the reforming catalyst layer, a high temperature is prevented by the heat capacity of the inert gas.

Water can be used as the nonflammable fluid. If water is used, a water vapor layer can be formed between the lean combustion gas for warmup and the rich raw fuel gas for reforming. As the temperature in the reformer is high, the supplied water is vaporized and the heat of the mixed gas is absorbed, so excessive rise of the temperature of the reformer can be suppressed.

When there is a shift from the warmup operation to the reforming operation, nonflammable fluid is supplied upstream of the reformer by the feeder. In the above embodiment, water (water vapor) is supplied upstream of the reforming reactor 2 of the reactors 2-4 situated furthest upstream which has a catalyst layer. This prevents the temperature from rising too much in the reformer, prevents catalyst deterioration and prevents damage to the reactors 2-4.

When there is a shift from the warmup operation to the reforming operation, after starting supply of the nonflammable fluid to the reformer by the water feeder 16, production of combustion gas in the startup burner 1 is stopped. Thus, a nonflammable fluid can be supplied between the lean combustion gas and rich raw fuel gas.

Using hydrocarbon fuel as the fuel for the startup burner 1, the amount of nonflammable fluid (water in the above embodiment) supplied to the reformer by the water feeder 16, is two or more times in terms of molar ratio relative to the number of carbon atoms in the lean combustion gas. In this way, the reaction temperature of mixed gas comprising lean combustion gas and rich raw fuel gas in the catalyst layers can be suppressed to 1000° C. or less, and the catalysts can be protected more effectively.

The water feeders 16, 17 are provided in one location in FIG. 1, but they may be provided in plural locations so that water is supplied from plural locations (similar for the other embodiments).

Embodiment 2

The construction of the fuel cell system of the second embodiment is identical to that of the first embodiment shown in FIG. 1. The control performed by the controller 7 is essentially identical to that of the first embodiment shown in FIG. 2, except that the processing in the step S6 differs from that of the first embodiment.

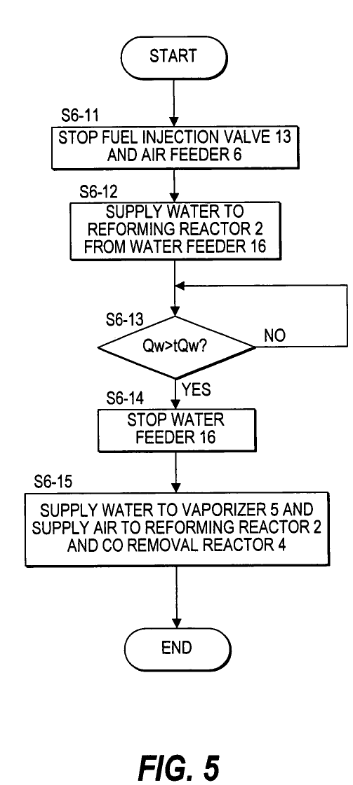

The operation change-over control from the warmup operation to the reforming operation in the step S6, will now be described referring to the flowchart shown in FIG. 5.

In a step S6-11, the air feeder 6 is stopped at the same time as the fuel injection valve 13 is stopped. The production of combustion gas is stopped by stopping the supply of fuel and air to the startup burner 1. In a step S6-12, the water feeder 16 is operated, water is supplied to the reforming reactor 2, and a water vapor layer is formed upstream of the lean combustion gas. In a step S6-13, it is determined whether or not the water supply amount Qw from the water feeder 16 exceeds the predetermined amount tQw. Supply is continued until it exceeds the predetermined amount tQw, and when it exceeds this amount tQw, the routine proceeds to a step S6-14 and the water feeder 16 is stopped.

In a step S6-15, the fuel feeder 14 and water feeder 15 are controlled to supply fuel and water to the vaporizer 5, and generate raw fuel gas. Simultaneously, the flowpath change-over valve 11 is changed over, air is supplied to the reforming reactor 2 and CO removal reactor 4, and the reforming reaction is started.

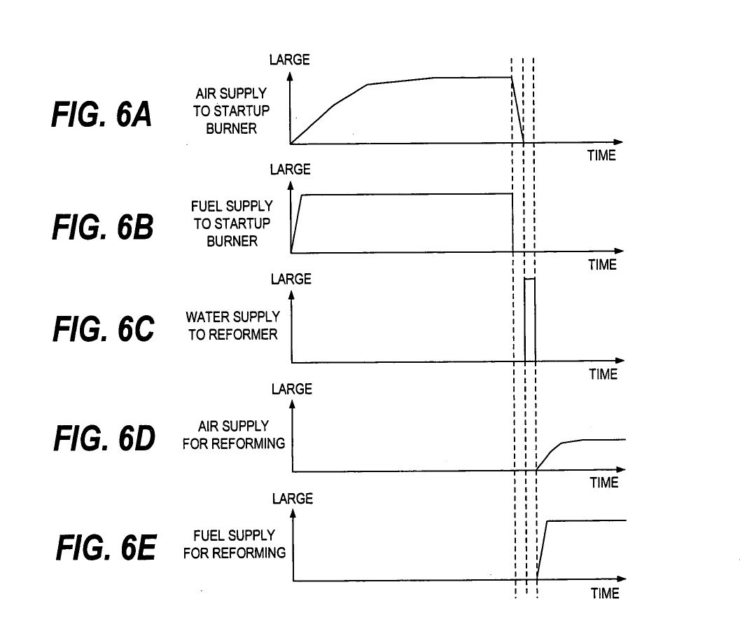

FIG. 6 is a timing chart at the time when the reforming system shifts from the warmup operation to the reforming operation.

After stopping the fuel supply to the startup burner 1, water is supplied from the water feeder 16. After stopping the supply of water, supply of rich raw fuel gas for reforming is started. Due to this, as shown in FIG. 11, a water vapor layer is formed upstream of the lean combustion gas, and rich raw fuel gas is formed further upstream. Hence, the admixture of lean combustion gas and rich raw fuel gas shown in FIG. 10, which would produce a gas mixture near the stoichiometric air-fuel ratio, is suppressed, and the temperature of the catalyst in the reformer is prevented from rising excessively. Moreover, as heat is absorbed by vaporization of water, excess temperature rise of the reformer can be prevented.

According to the second embodiment, when the reforming system shifts from the warmup operation to the reforming operation, after stopping production of combustion gas in the startup burner 1, supply of nonflammable fluid to the fuel reformer is started by the water feeder 17. A layer of nonflammable fluid is thereby formed between the lean combustion gas and rich raw fuel gas, and admixture of lean air fuel mixture and rich raw fuel gas which would give the stoichiometric air-fuel ratio, is avoided in the reformer.

Embodiment 3

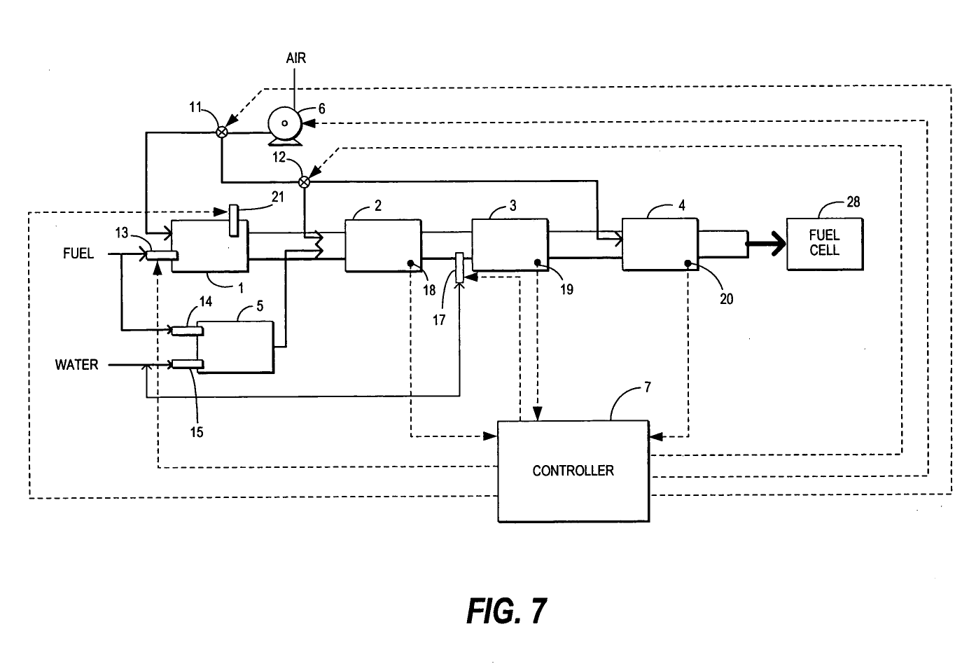

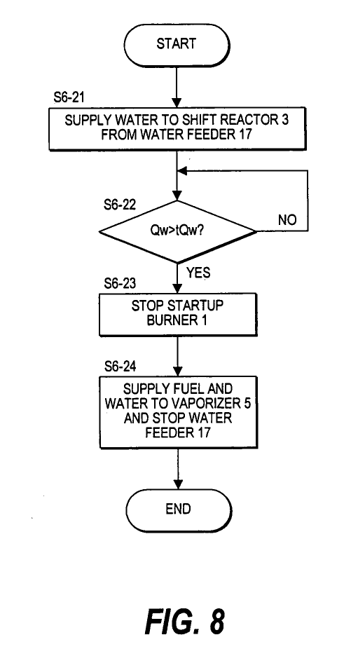

FIG. 7 shows the construction of the fuel cell system of the third embodiment. In the third embodiment, water is injected upstream of the shift reactor 3 from the water feeder 17. The water feeder 16 is omitted. When the fuel cell system starts, the control shown in FIG. 8, which is identical to that of the first embodiment, is thereby performed not using the water feeder 16, but using the water feeder 17, the timing chart when there is a shift from the warmup operation to the reforming operation being identical to that of FIG. 4.

According to the third embodiment, when there is a shift from the warmup operation to the reforming operation, nonflammable fluid is supplied by the water feeder 17 between the reforming reactor 2 and the shift reactor 3. Thus, a shift catalyst which has a lower heat resistance than the reforming reactor 2, and whose temperature tends to rise more easily above a permitted temperature, can be sufficiently cooled and protected.

Embodiment 4

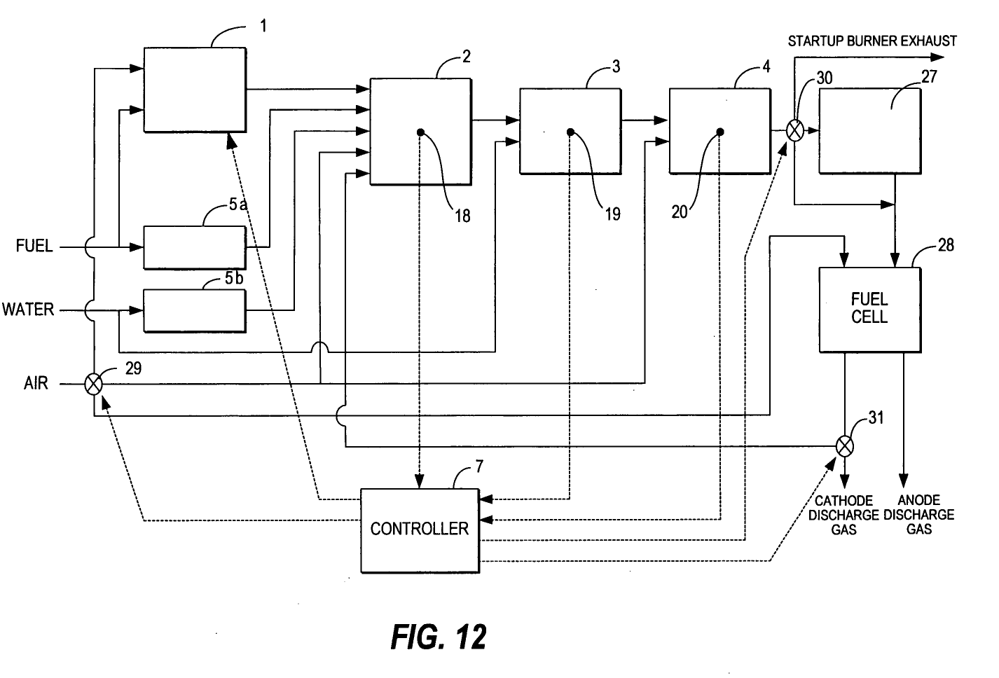

FIG. 12 shows the construction of the fuel cell system according to a fourth embodiment.

The fuel cell system has a fuel reforming system which is provided with a fuel vaporizer 5a which vaporizes fuel containing hydrogen atoms such as hydrocarbon fuel, and generates fuel vapor used for reforming, and a humidifying device 5b which vaporizes water, and generates water vapor used for reforming. Instead of the fuel vaporizer 5a and humidifying device 5b, an integrated vaporizer 5 as in the first-third embodiments may also be used.

Fuel vapor, water vapor and air as an oxidizing agent introduced by a compressor or blower, not shown, are supplied to the reforming reactor 2 in a predetermined ratio. In the reforming operation, the proportion of fuel and air supplied to the reforming reactor 2 is richer than the stoichiometric air-fuel ratio. After mixing the fuel vapor, water vapor and air upstream of the reforming reactor 2, they are introduced to the reforming catalyst, and hydrogen-rich reformate gas is generated.

In the shift reactor 3 and CO removal reactor 4, the amount of CO in the reformate gas is decreased to reduce deterioration of the platinum catalyst filled in the fuel cell stack 28 situated downstream. In the shift reactor 3, a shift reaction (CO+H₂O→H₂+CO₂) which decreases CO in reformate gas using water, is performed. In the CO removal reactor 4, in order to further decrease CO which is not completely removed in the shift reactor 3, an oxidizing agent (air) is used and the preferential oxidation (CO+1/2O₂→CO₂) of CO is performed.

The fuel reforming system further has a hydrogen storage tank 27 which stores the hydrogen-rich reformate gas produced by the reformer (i.e. reforming reactor 2, shift reactor 3 and CO removal reactor 4). The reformate gas stored in the hydrogen storage tank 27 is introduced into the fuel cell stack 28 during warmup of the reformer or when a high response, such as during vehicle acceleration, is required. In the fuel cell stack 28, power is generated using the reformate gas supplied directly from the reformer or via the hydrogen storage tank 27, and the oxidizing agent introduced by the compressor or blower, etc.

During the warmup operation of the reformer, fuel is supplied from the fuel injection valve to the startup burner 1, air is supplied via the compressor, blower, etc. The air fuel mixture is ignited by an ignition source, and a lean combustion gas is generated at high temperature. The generated lean combustion gas warms up the catalyst in the reactors 2-4 while passing through the reformer. The air-fuel ratio is set to be leaner than the stoichiometric air-fuel ratio. For example, considering the heat-resisting properties and exhaust performance of the reformer, the air-fuel excess λ is set to 2 or more.

The flowpath change-over valve 29 distributes the air introduced by the compressor, blower, etc. from outside, to the startup burner 1, the reactors in the reformer (reforming reactor 2, CO removal reactor 4), and the fuel cell stack 28.

During the warmup operation, air is supplied to the startup burner 1 by the flowpath change-over valve 29. Also, in the fourth embodiment, as power is generated by the fuel cell stack 28 and the heat accompanying power generation warms up the fuel cell stack 28, air is supplied also to the fuel cell stack 28. Supply of air to the reforming reactor 2 and CO removal reactor 4 stops. On the other hand, during the reforming operation, supply of air to the startup burner 1 is stopped, and air is distributed to the reforming reactor 2, CO removal reactor 4 and the fuel cell stack 28.

The flowpath change-over valve 30 is a valve which changes over the supply destination of the gas discharged from the reformer, and selectively communicates with the hydrogen storage tank 27, fuel cell stack 28 and the atmosphere. In the warmup operation of the fuel reforming system, as lean combustion gas used for warmup is discharged from the reformer, the flowpath change-over valve 30 is made to communicate with the atmosphere. On the other hand, in the reforming operation, hydrogen-rich reformate gas is discharged from the reformer, so it is distributed or selectively supplied to the hydrogen storage tank 27 and the fuel cell stack 28 according to the running state of the fuel cell stack 28.

The flowpath change-over valve 31 selectively supplies cathode discharge gas discharged from the cathode of the fuel cell stack 28 to one of a burner, not shown, and the fuel reforming system. After warmup of the reformer is complete, cathode discharge gas in which the oxygen has been reduced in the fuel cell stack 28 is supplied to the reformer by making the flowpath change-over valve 31 communicate with the fuel reforming system side, and production of a gas mixture having the stoichiometric air-fuel ratio in the reformer is suppressed. At other times, the flowpath change-over valve 31 is made to communicate with the burner, not shown, and hydrogen discharged from the anode is used for combustion processing.

Catalyst temperatures detected by a temperature sensor 18 which detects the catalyst temperature of the reforming reactor 2, a temperature sensor 19 which detects the catalyst temperature of the shift reactor 3, and a temperature sensor 20 which detects the catalyst temperature of the CO removal reactor 4, are input to the controller 7. The catalysts in the reactors 2-4 respectively have optimum running temperatures (e.g., catalyst activation temperatures), and target warmup temperatures are set accordingly.

Completion of warmup of the reformer is determined by determining whether or not the catalysts have reached the target warmup temperatures based on the outputs of the temperature sensors 18-20. When it is determined that warmup of the reformer is complete, a controller 7 outputs a control signal to the start-up burner 1, and the fuel reforming system shifts from the warmup operation to the reforming operation.

During the warmup operation, the fuel vaporizer 5a and water vaporizer 5b are warmed up by an electric heater, not shown, or by heat exchange with combustion gas from the burner, mentioned above. The fuel vaporizer 5a and water vaporizer 5b are warmed up beforehand so that a predetermined supply of fuel vapor and water vapor to the reforming reactor 2 can be started immediately after it is determined that warmup of the reformer is complete.

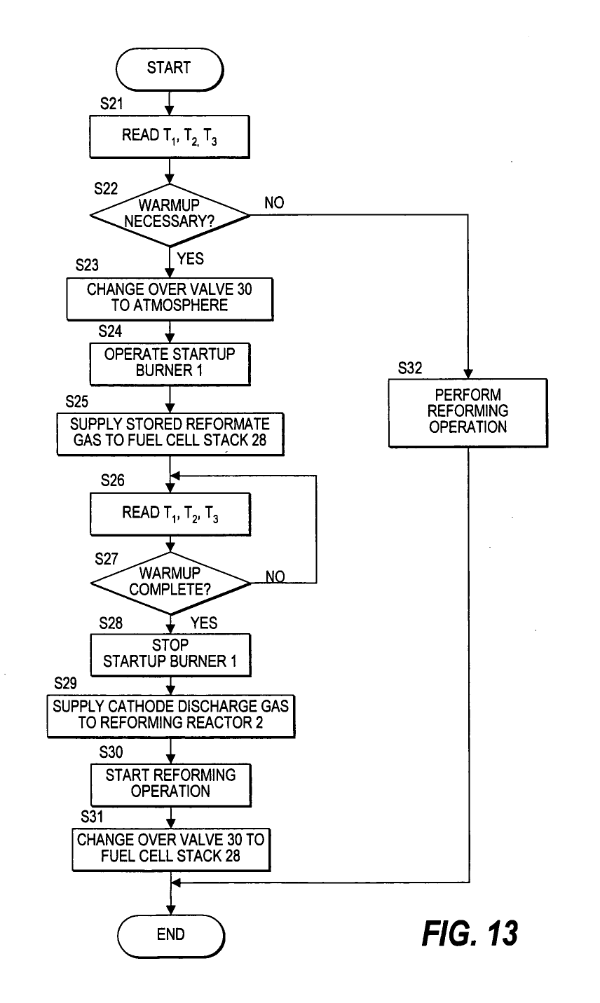

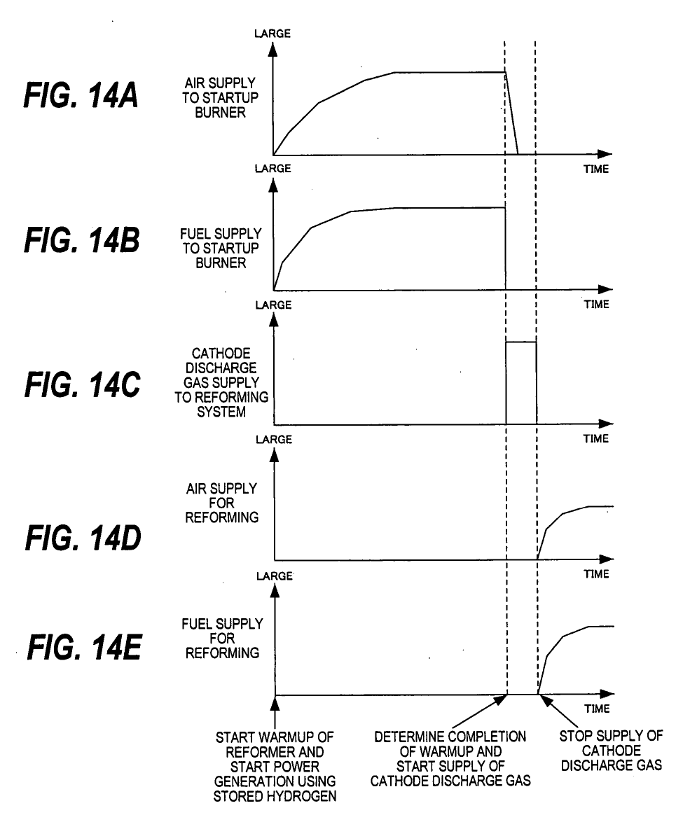

The control of change-over of the warmup operation to the reforming operation of the fuel reforming system will now be described referring to the flowchart of FIG. 13, and the timing charts of FIGS. 14A-14E.

From the temperatures T₁, T₂, T₃ of the reactors 2-4 detected by the temperature sensors 18-20, it is determined whether or not the warmup operation of the fuel reforming system is required (S21, S22) as is described in the first embodiment. When it is determined that the warmup operation is not required, fuel is supplied to the fuel vaporizer 5a, water is supplied to the water vaporizer 5b, and the reforming operation immediately begins (S32).

When it is determined that the warmup operation is required, the flowpath change-over valve 30 changes over to the atmosphere (S23), and combustion gas produced in the start-up burner 1 is supplied to the reformer to warm it up (S24). At this time, the flowpath change-over valve 29 which selects the air supply destination, communicates with the start-up burner 1 and fuel cell stack 28. Air supplied via the flowpath change-over valve 29 and fuel injected by a fuel injection valve, not shown, are supplied to the start-up burner 1 in a lean proportion, and burnt so as to produce lean combustion gas. The lean combustion gas flows into the reforming reactor 2, shift reactor 3 and CO removal reactor 4 to warm up the reformer.

The combustion gas used for warmup is discharged into the atmosphere by the flowpath change-over valve 30. Simultaneously, air and reformate gas from the hydrogen storage tank 27 are supplied to the fuel cell stack 28 (S25), and the fuel cell stack 28 warms itself up due to the heat emitted during power generation. Further, the fuel vaporizer 5a and water vaporizer 5b are warmed up by the electric heater, not shown, or by the heat exchange with combustion gas made by the discharged anode and cathode gas.

It is determined whether or not the catalyst temperatures T₁, T₂, T₃ of the reactors 2-4 detected by the temperature sensors 18-20 have reached the target warmup temperatures (S26, S27), and if they have reached the target warmup temperatures, supply of air and fuel to the startup burner 1 is stopped (S28). Although the fuel supply is stopped immediately, the air supply is stopped relatively slowly. This is in order to discharge lean combustion gas in the startup burner 1 by supplying air.

Simultaneously, cathode discharge gas discharged from the fuel cell stack 28 is supplied to the reforming reactor 2 (S29). In the cathode of the fuel cell stack 28, the cathode reaction (1/2O₂+2H⁺+2e⁻H₂O) takes place and cathode discharge gas with a low oxygen concentration is discharged, so the flowpath change-over valve 31 communicates with the reforming reactor 2. As a result, this cathode discharge gas is supplied as an inert gas to the reforming reactor 2 which is disposed furthest upstream of the reformer. When a predetermined amount of the cathode discharge gas has been supplied to the reformer, supply of the cathode discharge gas to the reformer is stopped. Supply of air to the startup burner 1 is stopped before finishing the supply of a predetermined amount of the cathode discharge gas, so that when the supply of cathode discharge gas is stopped, there is only cathode discharge gas filling at least the upstream part of the reformer.

The flowpath change-over valve 29 communicates with the reforming reactor 2 and the CO removal reactor 4, and supplies air thereto. When it is determined that warmup of the fuel vaporizer 5a and water vaporizer 5b is complete, fuel is supplied to the fuel vaporizer 5a, water is supplied to the water vaporizer 5b, and the reforming operation starts (S30). The ratio of fuel and air supplied to the reforming reactor 2 is set to be richer than the stoichiometric air-fuel ratio. The supply of hydrogen from the hydrogen storage tank 27 is then stopped by changing over the flowpath change-over valve 30 (S31), and hydrogen-rich reformate gas from the reformer is supplied so that the fuel cell stack 28 continues to generate power.

According to the fourth embodiment, the hydrogen storage tank 27 which stores hydrogen supplied to the fuel cell stack 28 during warmup of the reformer, is provided, and cathode discharge gas discharged from the fuel cell stack 28 after power generation is supplied as an inert gas to the boundary region between lean combustion gas and rich raw fuel gas.

By supplying cathode discharge gas, mixing of the lean combustion gas and rich raw fuel gas is prevented, and reactions of gases in the vicinity of the stoichiometric air-fuel ratio in the reforming catalyst layer which would lead to high temperature, are prevented. Even if gas reactions in the vicinity of the stoichiometric air-fuel ratio do occur in the reforming catalyst layer, high temperature is prevented by the heat capacity of the cathode discharge gas. In particular, cathode discharge gas wherein the oxygen concentration is reduced due to power generation is used, so oxidation reactions, which are exothermic reactions, are suppressed. Further, the cathode discharge gas is a discharge gas of the fuel cell stack 28, so there is no need to produce or store an inert gas, and temperature suppression can be efficiently performed.

Embodiment 5

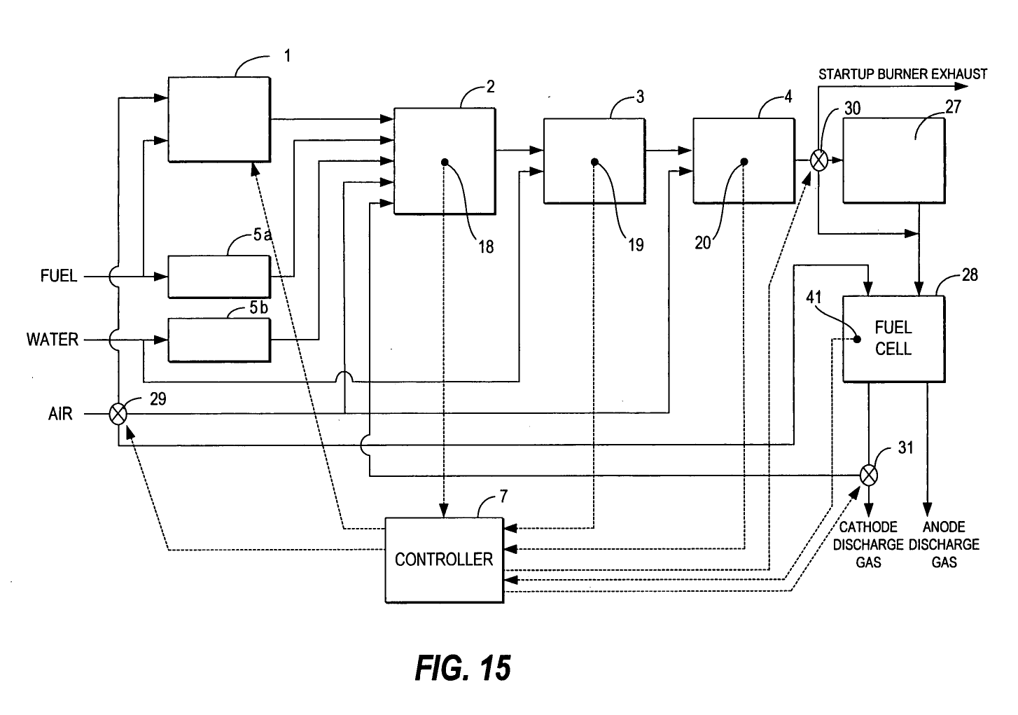

FIG. 15 shows the construction of the fuel cell system according to a fifth embodiment. The following description will focus on the differences from the fourth embodiment.

The fuel cell stack 28 comprises a temperature sensor 41 for determining whether or not the fuel cell stack 28 is operating stably. When it is determined that the stack temperature detected by the temperature sensor 41 has reached a predetermined value, e.g. 0° C. or higher, it is determined that warmup of the fuel cell stack 28 is complete, and that normal power generation can be performed. It can also be determined whether or not the fuel cell stack 28 is stable, by detecting the voltage of the fuel cell stack 28 with a voltage sensor or the like.

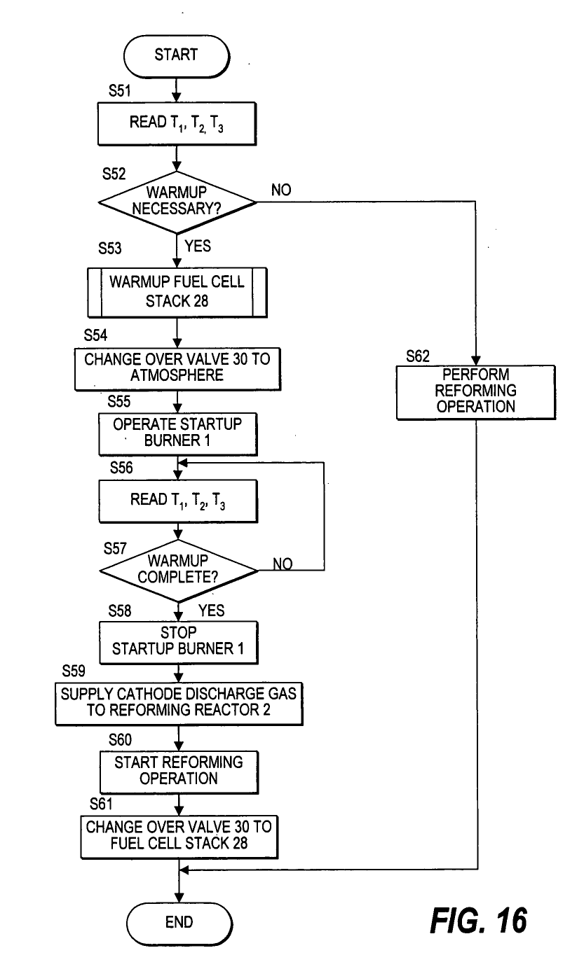

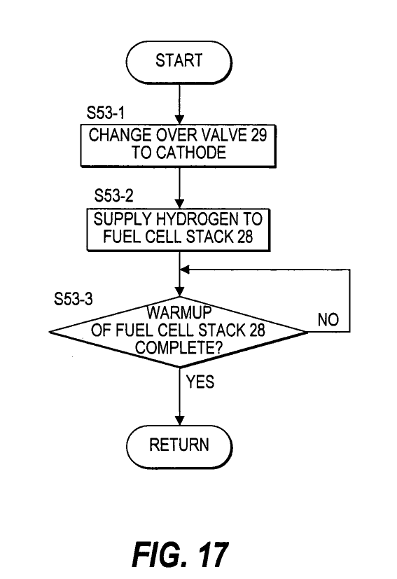

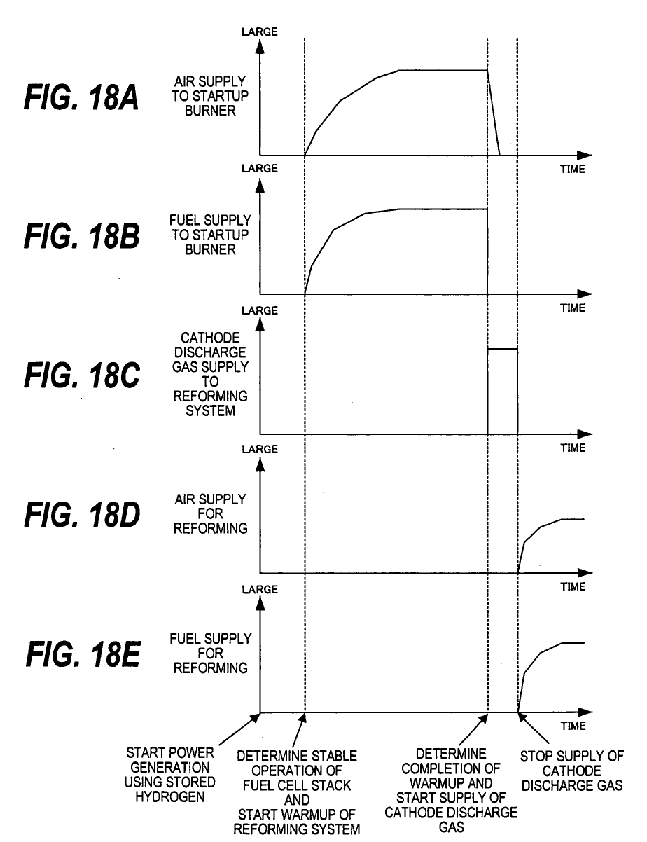

The parts which are different from the fourth embodiment when there is a shift of the fuel reforming system from the warmup operation to the reforming operation, will now be described referring to the flowcharts of FIGS. 16, 17, and the timing charts of FIGS. 18A-18E.

From the temperatures of the reactors 2-4 detected by the temperature sensors 18-20 with which the reactors 2-4 are provided, it is determined whether the warmup operation of the fuel cell stack 28 is required (S51). Also an outside temperature sensor, not shown, may be used additionally for the determination. When it is determined that the warmup operation is not required, fuel is supplied to the fuel vaporizer 5a, water is supplied to the water vaporizer 5b, and reforming starts (S62).

When it is determined that the warmup operation is required, air is supplied to the cathode of the fuel cell stack 28 via the flowpath change-over valve 29 (S53-1). Hydrogen is supplied to the anode of the fuel cell stack 28 from the hydrogen storage tank 27 (S53-2). Due to this, the fuel cell stack 28 starts generating power, and warmup of the fuel cell stack 28 is performed using the heat accompanying power generation. Simultaneously, the output of the temperature sensor 41 with which the fuel cell stack 28 is provided, is monitored.

From the output from the temperature sensor 41, it can be determined that a predetermined temperature has been reached at which warmup of the fuel cell stack 28 is complete and power generating reactions have stabilized (S53-3). When the fuel cell stack 28 reaches the predetermined temperature, the flowpath change-over valve 30 is changed over to the atmosphere (S54), and combustion in the startup burner 1 starts (S55). Air is supplied to the startup burner 1 via the flowpath change-over valve 29, fuel is injected from the fuel injection valve, and the mixture of air and fuel is ignited by an ignition source to burn it. The fuel cell stack 28 then continues generating power.

As in the case of the first embodiment, this state is maintained until it is determined, from the catalyst temperatures T₁, T₂, T₃ of the reactors 2-4 of the reformer detected by the temperature sensors 18-20, that the catalysts of the reactors 2-4 have reached the target warmup temperatures (S56, S57), and at that time, the supply of air and fuel to the startup burner 1 is stopped (S58). A predetermined amount of cathode discharge gas, in which the oxygen concentration has been considerably reduced due to stable power generation, is supplied to the reformer (S59), and when the oxygen concentration in the reformer has been reduced, fuel and water are supplied to the reforming reactor 2 to start the reforming reaction (S60). The flowpath change-over valve 30 then changes over to the fuel cell stack 28, hydrogen supply from the hydrogen storage tank 27 is stopped (S61), hydrogen-rich reformate gas from the reformer is supplied to the fuel cell stack 28 instead, and power is generated.

According to the fifth embodiment, the temperature sensor 41 is provided as a means of determining whether or not power generation by the fuel cell stack 28 is stable, and if it is determined that power generation in the fuel cell stack 28 is stable, the warmup operation of the reforming system starts. Due to this, warmup of the reformer starts when the oxygen concentration of the cathode discharge gas has sufficiently decreased due to power generation reactions. In other words, when warmup is complete and the reforming operation starts, cathode discharge gas in which the oxygen concentration has sufficiently been reduced, can be supplied to the reformer. Hence, mixing of lean combustion gas for warmup and rich raw fuel gas for reforming, which would give an air-fuel ratio approaching the stoichiometric air-fuel ratio, is suppressed, and excessive rise of the catalyst temperature of the reformer is suppressed.

Embodiment 6

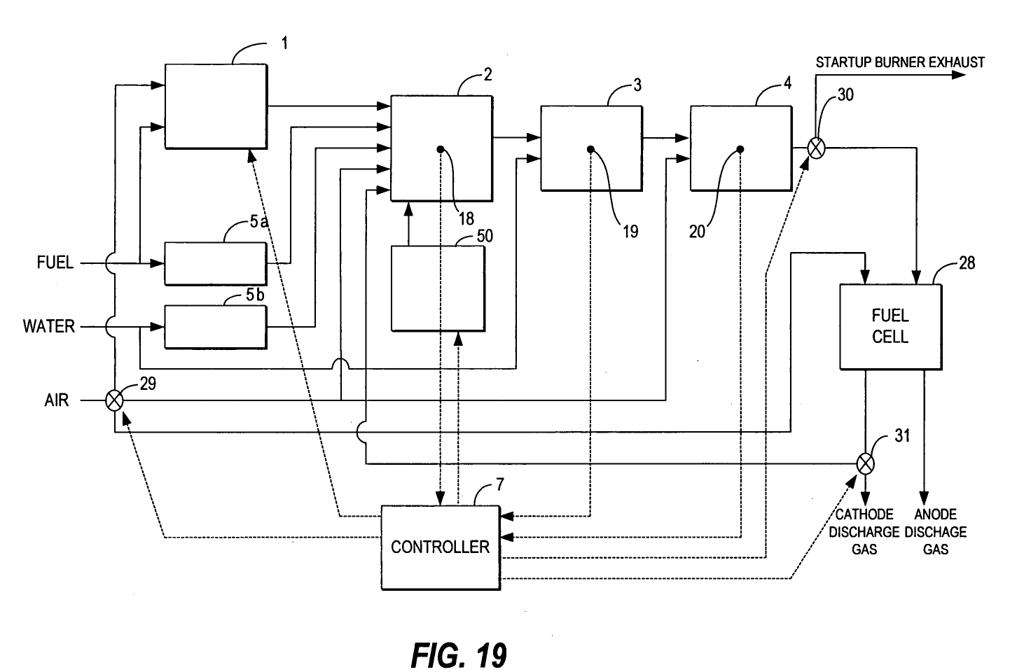

FIG. 19 shows the construction of a fuel cell system according to a sixth embodiment. The following description will focus on the differences from the first embodiment. In the sixth embodiment, the hydrogen storage tank 27 is not provided, and the fuel cell stack 28 generates power using only the hydrogen-rich reformate gas supplied from the reformer. The flowpath change-over valve 30 selects whether to supply the gas discharged from the fuel reforming system to the fuel cell stack 28, or to discharge it. Also, when the fuel cell system starts up, and there is a shift of the reforming system from the warmup operation to the reforming operation, nitrogen gas is used as the inert gas of low oxygen concentration filling the inside of the reformer.

In order to supply nitrogen to the reforming reactor 2 which is situated furthest upstream in the reformer, the fuel reforming system has a nitrogen gas storage and supply apparatus 50. Upon a command from the controller 7, nitrogen is supplied from the nitrogen gas storage and supply apparatus 50 to the reformer. Due to this, there is no need to fill the reformer with cathode discharge gas, the flowpath change-over valve 31 is unnecessary, and all the cathode discharge gas discharged from the fuel cell stack 28 is supplied to the burner, not shown. As in the control of the first and second embodiments, nitrogen can be supplied instead of water.

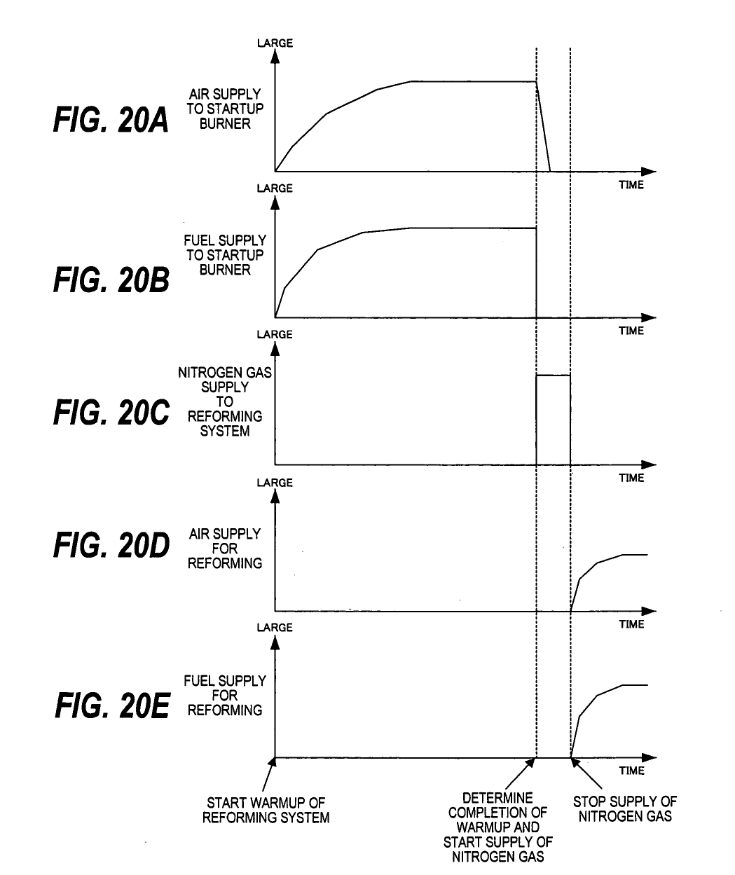

The control which is different from the first embodiment when the fuel cell system starts, and the fuel cell system shifts from the warmup operation to the reforming operation, will now be described referring to timing charts shown in FIGS. 20A-20E.

When a warmup operation command is detected, supply of air and fuel to the startup burner 1 is started, and combustion gas is produced. The combustion gas flows through the reformer, and warms up the reactors 2-4. At this time, power generation by the fuel cell stack 28 is stopped. If necessary, the fuel cell stack 28 can be warmed up by an electric heater or by another burner, not shown. Alternatively, the flowpath change-over valve 30 may be changed over to the fuel cell stack 28, and the combustion gas produced by the startup burner 1 may be supplied also to the fuel cell stack 28 via the reformer so as to warm up the fuel cell stack 28. However, in this case, the combustion gases supplied to the fuel cell stack 28 from the fuel reforming system must be in such a composition that they do not deteriorate the fuel cell stack 28.

When it is determined that the reactors 2-4 have reached the target warmup temperatures, supply of nitrogen from the nitrogen gas supply and storage apparatus 50 to the reformer starts. After a predetermined amount of nitrogen gas has been supplied, the supply of nitrogen gas is stopped, and water vapor and fuel vapor are supplied to the reformer to start the reforming operation. The flowpath change-over valve 30 is then changed over to the fuel cell stack 28, and power generation starts.

According to the sixth embodiment, nitrogen is supplied as an inert gas to the boundary region between the lean gas and rich gas, so mixing of lean gas and rich gas is prevented. By providing the nitrogen gas storage and supply apparatus 50, and using nitrogen gas as the nonflammable fluid, the oxygen concentration in the reformer can be adjusted regardless of the state of the fuel cell system. As a result, there is no need to wait until the fuel cell stack has finished warming up and it starts stable operation, and the time until the fuel reforming system shifts to the reforming operation can be shortened.

Embodiment 7

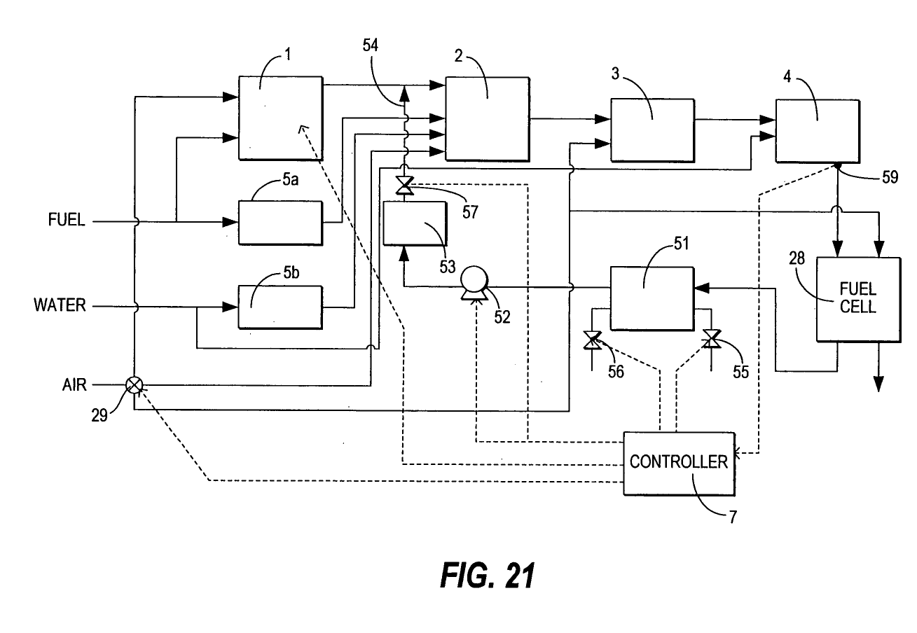

FIG. 21 shows the construction of a fuel cell system according to a seventh embodiment.

As in the fourth embodiment, the startup burner 1, fuel vaporizer 5a and water vaporizer 5b are provided. The reformer comprises the reforming reactor 2, shift reactor 3 and CO removal reactor 4. The fuel cell stack 28 generates power using hydrogen-rich reformate gas produced by the fuel reforming system. The flowpath change-over valve 29 supplies air introduced from outside selectively to the startup burner 1, reformer and fuel cell stack 28. Further, a temperature sensor 59 is installed downstream of the reformer, which herein is downstream of the CO removal reactor 4.

The fuel cell system further comprises a burner 51 (discharge hydrogen burner). The burner 51 burns anode discharge gas comprising residual hydrogen discharged from the fuel cell stack 28. The burner 51 may for example be a catalyst burner. A recycling line 54 which supplies combustion gas produced by the burner 51 to the reformer, is provided downstream of the burner 51. The combustion gas produced by the burner 51 is supplied to the reforming reactor 2 which is situated furthest upstream of the reformer. The recycling line 54 is connected to a passage which supplies combustion gas from the startup burner 1 to the reforming reactor 2.

The recycling line 54 comprises a blower 52 and buffer tank 53. By operating the blower 52, combustion gas which is inert gas produced by the burner 51 is recycled, and stored in the buffer tank 53. A valve 57 is provided at the outlet of the buffer tank 53. The valve 57 is opened or closed to select whether or not to recycle the gas in the buffer tank 53 and recycling line 54 to the fuel reforming system.

Air is supplied to the burner 51 as an oxidizing agent. The air introduced by a compressor or blower, not shown, is supplied to the burner 51 via a valve 55. The compressor or blower which introduces the air may be identical to the compressor or blower which introduces air to the aforesaid startup burner 1, or they may be provided separately. Also, a discharge passage which communicates with the outside atmosphere is connected to the burner 51, a valve 56 being fitted to this discharge passage. The pressure inside the burner 51 is adjusted by opening and closing the valve 56.

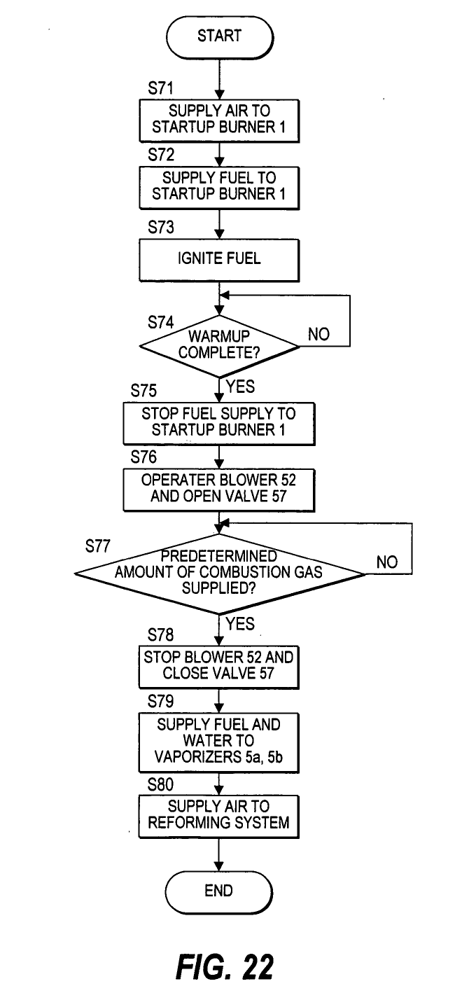

The control in the seventh embodiment where the reforming system is changed over from the warmup operation to the reforming operation, will now be described referring to the flowchart shown in FIG. 22. This flowchart is executed by the controller 7, and starts when it is determined, from one or more of the outside air temperature, temperature of the sensors 2-4 and temperature of the fuel cell stack 28, that the warmup operation is required.

In a step S71, introduction of oxidizing agent gas to the startup burner 1 is started. Air is supplied by the compressor or blower, not shown, via the flowpath change-over valve 29 as the oxidizing agent gas. In a step S72, fuel is introduced to the startup burner 1 by a fuel injection valve, not shown. In a step S73, the introduced fuel is ignited by an ignition source. Due to this, lean combustion gas is produced in the startup burner 1, and the reformer is warmed up by passing the lean combustion gas through the reforming reactor 2, shift reactor 3 and CO removal reactor 4.

The lean combustion gas discharged from the reformer is made to flow through the anode of the fuel cell stack 28, and warms up the fuel cell stack 28. Further, the lean combustion gas discharged from the fuel cell stack 28 is made to flow to the burner 51, and warms up the catalyst filling the burner 51. At this time, the valve 56 is open, the valve 57 is closed, and the blower 52 has stopped. Therefore, the lean combustion gas supplied to the burner 51 does not flow into the recycling line 54, and is discharged via the valve 56.

In a step S74, it is determined whether or not warmup is complete. The temperature downstream of the reformer, i.e. the outlet temperature of the CO removal reactor 4, is detected by the temperature sensor 59, and when the combustion gas temperature at the outlet of the CO removal reactor 4 reaches a predetermined temperature or above, it is determined that warmup is complete. The predetermined temperature used for the determination is set to the temperature of the gas discharged from the reformer when combustion gas is supplied at 100-120° C. for warmup, and warmup of the reactors 2-4 is complete. It may for example be preset based on experimental results.

The warmup operation is continued until the temperature of the combustion gas discharged from the reformer reaches the predetermined temperature, and when it reaches the predetermined temperature, it is determined that warmup is complete and the routine proceeds to a step S75. The determination of whether warmup is complete, may be made by determining whether or not the catalysts in the reactors 2-4 and burner 51 have reached the target warmup temperatures. By supplying air and water as necessary to the reactors 2-4, burner 51 and fuel cell stack 28, excessive temperature rise of these devices is suppressed.

In a step S75, supply of fuel to the startup burner 1 is stopped. Combustion in the startup burner 1 is thereby stopped, and warmup operation is completed. In a step S76, the valve 57 is opened, the blower 52 is operated, and combustion gas, which is an inert gas stored in the buffer tank 53, is introduced to the reforming reactor 2. As a result, combustion gas having a low oxygen concentration which was stored in the buffer tank 53, is made to flow into the reforming reactor 2.

In a step S77, supply of combustion gas is maintained until it is determined that the predetermined amount of combustion gas from the buffer tank 53 has been supplied to the fuel reforming system. When it is determined that the predetermined amount has been supplied, it is determined that a sufficient amount of combustion gas having a low oxygen concentration has been supplied to the reformer, and the routine proceeds to a step S78. Alternatively, the relation between the load of the blower 52 and the time required to fill the reformer with combustion gas may first be preset by experiment, and then the determination may be made after the predetermined time has elapsed based on the load of the blower 52.

In a step S78, the blower 52 is stopped, the valve 57 is closed, and supply of inert gas to the reforming reactor 2 is stopped. In a step S79, fuel and water are respectively supplied to the fuel vaporizer 5a and water vaporizer 5b, which have been warmed up.

In a step S80, air is supplied to the reforming reactor 2 and CO removal reactor 4 via the flowpath change-over valve 29. Water is also supplied to the shift reactor 3, and the reforming operation starts. Further, air is supplied to the cathode by making the flowpath change-over valve 29 communicate with the fuel cell stack 28. As a result, hydrogen-rich reformate gas is produced by the fuel reforming system, and power is generated in the fuel cell stack 28 by using the reformate gas. The anode discharge gas from the fuel cell stack 28 is burnt in the burner 51, and discharged via the valve 56.

When the fuel cell system is stopped, the burner 51 performs partial combustion of recycled anode gas to produce inert gas. The combustion gas is supplied downstream. Then the system is stopped when the reactors and the buffer tank 53 are filled with the inert gas.

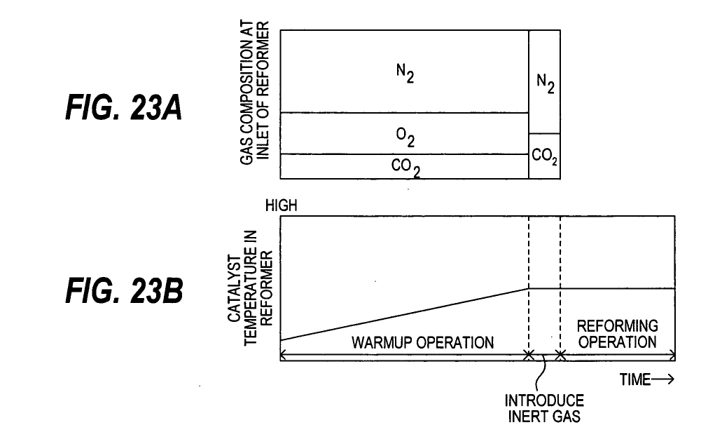

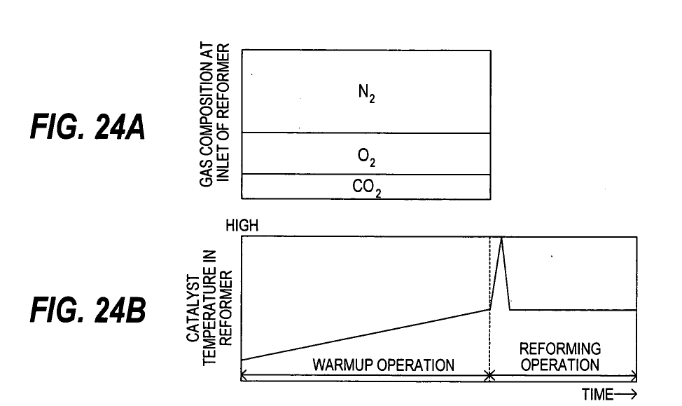

FIGS. 23A-23B show the catalyst temperature time variation when control is performed in this way. As a comparison, the catalyst temperature time variation when lean combustion gas is supplied to the reformer followed by rich raw fuel gas, is shown in FIGS. 24A-24B.

In the comparison example shown in FIGS. 24A-24B, when warmup of the reformer is complete and the reforming operation starts, oxygen in the lean combustion gas is mixed with the rich raw fuel gas, and a part having the stoichiometric air-fuel ratio is produced. Due to this, the temperature of the reforming reactor 2 rises excessively immediately after the reforming operation startup, and there is a risk of catalyst deterioration due to sintering, etc. On the other hand, in the seventh embodiment shown in FIGS. 23A-23B, when there is a shift from the warmup operation to the reforming operation, a layer of inert gas is formed between the lean combustion gas and rich raw fuel gas, so admixture of oxygen in the lean combustion gas with the rich raw fuel gas, producing the stoichiometric air-fuel ratio, is suppressed.

According to the seventh embodiment, the fuel cell stack 28 which generates power using hydrogen-containing gas, the burner 51 which burns the hydrogen in the gas discharged from the fuel cell stack 28, and the discharge gas buffer tank 53 which stores gas discharged from the burner 51, are provided. Burnt discharge gas stored in the buffer tank 53 is used as the nonflammable fluid. Hence, burnt discharge gas which has a low oxygen concentration due to combustion, is supplied between the lean combustion gas and rich raw fuel gas, so production of a gas mixture in the vicinity of the stoichiometric air-fuel ratio in the reformer is prevented.

The reforming system which produces hydrogen-rich reformate gas by reforming hydrogen-containing fuel, the fuel cell stack 28 which generates power using this reformate gas, and the burner 51 which processes the hydrogen in the discharge gas from the fuel cell stack 28, are provided. Also provided are the recycling line 54 which is connected from the burner 51 to the inlet of the reformer, and the buffer tank 53 which stores burnt discharge gas from the burner 51. Hence, after the warmup operation of the reforming system is complete and there is a change-over to the reforming operation, the inert gas in the buffer tank 53 is temporarily introduced to the reformer by the recycling line 54, and subsequently, fuel can be supplied and a change-over to the reforming operation can be performed.

An inert gas layer is formed between a lean layer (excess air layer) formed by lean combustion gas during the warmup operation, and a rich layer (excess fuel layer) formed during the reforming operation, and separates the lean layer and rich layer. In this way, rapid catalyst temperature rise when there is a shift from the warmup operation to the reforming operation is suppressed, condensation of water vapor is eliminated, and decreased catalyst performance is prevented.

The blower 52 which can introduce gas in the buffer tank 53 and recycling line 54 to the reformer inlet, is provided. Hence, selective control can be performed as to whether to supply burnt discharge gas, which is the inert gas in the buffer tank 53 and recycling line 54, to the reformer. Further, by performing partial combustion while recycling reformate gas when the system has stopped, the fuel cell system including the buffer tank 53 can be stopped with full of inert gas therein. As a result, when the fuel cell system is restarted and there is a shift from the warmup operation to the reforming operation, the inert gas in the buffer tank 53 which was stored when the system stopped, can be used, therefore, excessive temperature rise of the catalyst layer can be prevented, condensation of water vapor can be eliminated, and decreased catalyst performance can be suppressed.

The startup burner 1 which produces combustion gas during startup, is provided, so when there is a shift from the warmup operation which performs lean combustion in the startup burner 1, to the reforming operation, the gas in the buffer tank 53 passes through the recycling line 54 and is temporarily introduced to the inlet of the reformer. In this way, burnt discharge gas which has a low oxygen concentration due to combustion, can be supplied between lean combustion gas and rich raw fuel gas, and production of a gas mixture in the vicinity of the stoichiometric air-fuel ratio in the fuel reforming system, can be prevented.

The determination of when warmup of the reforming system is complete, and when a change-over can be made to the reforming operation, i.e., when the gas in the buffer tank 53 can be introduced to the reformer, is based on the temperature at the reformer outlet. When warmup of the reformer is complete and there is a shift to the reforming operation, inert gas of low oxygen concentration can be introduced to the reformer. As a result, rapid catalyst temperature rise when the fuel reforming system changes over from the warmup operation to the reforming operation, is suppressed, condensation of water vapor is eliminated, decline of catalyst performance is prevented, and change-over of operating state can be rapidly performed.

In this embodiment, combustion gas from the startup burner 1 is used to warm up the reformer, but the warmup may also be performed using combustion gas from a burner which produces heat energy by burning discharged gas from the fuel cell stack 28.

The entire contents of Japanese Patent Applications P2002-32386 (filed Feb. 8, 2002) and P2002-335036 (filed Nov. 19, 2002) are incorporated herein by reference.

Although the invention has been described above by reference to a certain embodiments of the invention, the invention is not limited to the embodiments described above. Modifications and variations of the embodiments described above will occur to those skilled in the art, in the light of the above teachings. The scope of the invention is defined with reference to the following claims.

### INDUSTRIAL FIELD OF APPLICATION

This invention can be used for a fuel cell power plant system, but is not limited to vehicle fuel cell power plant systems. This invention is effective for protecting the catalyst in a fuel reforming system, and improving reliability thereof.

1. A fuel reforming system, comprising:
a reformer which produces a reformate gas from a rich raw fuel gas during a reforming operation,
a burner which produces a lean combustion gas, and supplies the lean combustion gas to the reformer during a warmup operation,
a nonflammable fluid supply apparatus which supplies a nonflammable fluid other than fuel and air to the reformer, and
a controller functioning to:
supply the lean combustion gas from the burner to the reformer during the warmup operation and
when the warmup operation of the reformer is complete, supply the nonflammable fluid from the nonflammable fluid supply apparatus to the reformer, and then supply the rich raw fuel gas to the reformer to start fuel reforming.

2. The fuel reforming system as defined in claim 1, wherein the nonflammable fluid is a fluid which is an inert with respect to fuel.

3. The fuel reforming system as defined in claim 2, wherein the nonflammable fluid is water.

4. The fuel reforming system as defined in claim 3, wherein:
the burner burns a hydrocarbon fuel at a lean air-fuel ratio to produce the lean combustion gas, and
the controller further functions to:
supply an amount of nonflammable fluid from the nonflammable fluid supply apparatus to the reformer which is 2.0 or more in terms of molar ratio relative to the number of carbon atoms in the lean combustion gas.

5. The fuel reforming system as defined in claim 1, wherein the nonflammable fluid supply apparatus is a supply apparatus which supplies the nonflammable fluid upstream of the reformer.

6. The fuel reforming system as defined in claim 1, wherein the reformer comprises a reforming reactor which reforms rich raw fuel gas, and a CO reduction system which reduces the CO concentration in the reformate gas, and
the nonflammable fluid supply apparatus is a supply apparatus which supplies the nonflammable fluid between the reforming reactor and the CO reduction system.

7. The fuel reforming system as defined in claim 1, wherein:
the controller further functions to:
stop the supply of lean combustion gas from the burner to the reformer after starting supply of the nonflammable fluid from the nonflammable fluid supply apparatus to the reformer.

8. The fuel reforming system as defined in claim 1, wherein:
the controller further functions to:
start the supply of nonflammable fluid from the nonflammable fluid supply apparatus to the reformer, after stopping the supply of the lean combustion gas from the burner to the reformer.

9. The fuel reforming system as defined in claim 1, wherein:
the nonflammable fluid is nitrogen gas, and
the nonflammable fluid supply apparatus is a supply apparatus which stores nitrogen gas, and supplies the nitrogen gas to the reformer.

10. The fuel reforming system as defined in claim 1, further comprising:
a sensor which detects the outlet temperature of the reforming system, wherein:
the controller further functions to:
determine completion of warmup of the reforming system based on the outlet temperature of the reforming system.

11. A fuel cell system having the fuel reforming system as defined in claim 1, comprising:
a fuel cell to which the reformate gas is supplied by the fuel reforming system, and the fuel reforming system further comprising:
a hydrogen storage mechanism which stores hydrogen supplied to the fuel cell during the warmup operation of the fuel reforming system, wherein
the nonflammable fluid supply apparatus supplies a cathode discharge gas discharged from the fuel cell after power generation to the reformer as the nonflammable fluid.

12. The fuel cell system as defined in claim 11, wherein:
the controller further functions to:
determine whether or not power is generated stably by the fuel cell, and
when it is determined that power is generated stably by the fuel cell, start warmup of the fuel reforming system.

13. A fuel cell system having the fuel reforming system as defined in claim 1, comprising:
a fuel cell to which the reformate gas is supplied by the fuel reforming system, and
the fuel reforming system wherein the nonflammable fluid supply apparatus comprises:
a discharge hydrogen burner which burns unconsumed hydrogen discharged from the fuel cell, and
a buffer tank which stores burnt discharge gas discharged from the discharge hydrogen burner, and supplies the burnt discharge gas to the reformer, and the nonflammable fluid is the discharge gas stored in the buffer tank.

14. The fuel cell system as defined in claim 13, wherein:
the nonflammable fluid supply apparatus further comprises a blower which introduces gas in the buffer tank and upstream of the reformer.

15. The fuel cell system as defined in claim 13, further comprising:
a recycling line which connects the discharge hydrogen burner to the upstream of the reforming system, wherein:
the nonflammable fluid supply apparatus introduces the discharge gas in the buffer tank upstream of the reforming system via the recycling line.

16. A fuel cell system, comprising:
a fuel cell,
a reformer which produces a reformate gas from a rich raw fuel gas, and supplies the reformate gas to the fuel cell during a reforming operation,
a burner which produces a lean combustion gas, and supplies the lean combustion gas to the reformer during a warmup operation,
a nonflammable fluid supply apparatus which supplies a nonflammable fluid other than fuel and air to the reformer, and
a controller functioning to:
when the reformer shifts from the warmup operation to the reforming operation, supply the nonflammable fluid from the nonflammable fluid supply apparatus to the reformer, and form a layer of the nonflammable fluid between the lean combustion gas supplied from the burner to the reformer and the rich raw fuel gas supplied to the reformer.

17. A control method of a fuel cell system having a fuel cell, a reformer which produces a reformate gas from a rich raw fuel gas and supplies the reformate gas to the fuel cell during a reforming operation, and a burner which produces a lean combustion gas and supplies the lean combustion gas to the reformer during a warmup operation of the reformer, the method comprising:
supplying the lean combustion gas from the burner to the reformer during the warmup operation of the reformer and
when the warmup operation of the reformer is complete, supplying the nonflammable fluid to the reformer, and then supplying the rich raw fuel gas to the reformer to start fuel reforming.

18. A fuel cell system, comprising:
a fuel cell,
a reformer which produces a reformate gas from a rich raw fuel gas, and supplies the reformate gas to the fuel cell during a reforming operation,
a burner which produces a lean combustion gas, and supplies the lean combustion gas to the reformer during a warmup operation of the reformer,
a nonflammable fluid supply apparatus which supplies a nonflammable fluid other than fuel and air to the reformer,
means for supplying the lean combustion gas from the burner to the reformer during the warmup operation of the reformer and
means for, when the warmup operation of the reformer is complete, supplying the nonflammable fluid from the nonflammable fluid supply apparatus to the reformer, and then supplying the rich raw fuel gas to the reformer to start fuel reforming.
